(19) United States
(12) Patent Application Publication
(10) Pub. No.: US 2022/0371563 A1
(43) Pub. Date: Nov. 24, 2022

(54) PRESSURE GENERATION UNIT FOR A BRAKING SYSTEM

(71) Applicant: ZF Active Safety GmbH, Koblenz (DE)

(72) Inventor: Frank Einig, Ochtendung (DE)

(21) Appl. No.: 17/748,253

(22) Filed: May 19, 2022

(30) Foreign Application Priority Data
May 20, 2021 (DE) 102021113147.2

(51) Int. Cl. B60T 13/66; B60T 13/74; B60T 17/08; F15B 15/18

(52) U.S. Cl. CPC B60T 13/662; B60T 13/745; B60T 17/08; F15B 15/18; F15B 2211/20515

(57) ABSTRACT

The disclosure relates to a pressure generation unit for a braking system. The pressure generation unit comprises an electric drive motor and a hydraulic piston which is displaceable by the electric drive motor in order to selectively apply pressure to or relieve pressure from a pressure fluid circuit delimited by the hydraulic piston. For this purpose, the electric drive motor is drivingly coupled to the hydraulic piston via a planetary gear mechanism and a rack-and-pinion gear mechanism.

### CROSS-REFERENCE TO RELATED APPLICATION

This application claims priority to German Priority Application No. 102021113147.2, filed May 20, 2021, the disclosure of which is incorporated herein by reference in its entirety.

### TECHNICAL FIELD

The disclosure relates to a pressure generation unit for a braking system, in particular for a brake-by-wire braking system, comprising an electric drive motor and a hydraulic piston which is displaceable by the electric drive motor in order to selectively apply pressure to or relieve pressure from a pressure fluid circuit delimited by the hydraulic piston.

### BACKGROUND

Pressure generation units are known from the prior art and are often used in motor vehicles.

Put simply, a pressure generation unit's operating principle is based on converting a rotational movement of the electric drive motor into a translational movement of the hydraulic piston. The pressure generation units can thus supply e.g. wheel-side brake actuators with hydraulic pressure. Accordingly, known pressure generation units are often also referred to as master cylinders.

Since braking systems are safety-relevant devices in motor vehicles, high demands must be placed on the reliability of pressure generation units.

At the same time, however, there are high cost pressures, particularly in the field of motor vehicle production, and this does not stop at braking systems and their components. The aim is thus also to build braking systems as simply and inexpensively as possible.

These requirements are obviously in conflict with each other, since inexpensive components are usually associated with a reduced degree of reliability.

### SUMMARY

What is needed is to mitigate or resolve this conflict of aims. The aim is thus to provide a pressure generation unit which is simple and inexpensive to construct without compromising reliability.

To this end, a pressure generation unit of the type mentioned at the outset is disclosed herein, in which an electric drive motor is drivingly coupled to a hydraulic piston via a planetary gear mechanism and a rack-and-pinion gear mechanism. Planetary gear mechanisms and rack-and-pinion gear mechanisms are simple and inexpensive standard components available on the market. A rotational movement can be converted into a translational movement in a particularly simple manner through the use of a rack-and-pinion gear mechanism. Planetary gear mechanisms are extremely compact, especially in view of the gear ratios that they can provide. In addition, planetary gear mechanisms and rack-and-pinion gear mechanisms usually operate with a very high level of reliability. In addition, planetary gear mechanisms and rack-and-pinion gear mechanisms operate with relatively little loss, i.e. they can be operated efficiently. The conflict of aims of a simple and inexpensive design and high reliability is thus solved with a pressure generation unit according to the disclosure.

According to one exemplary arrangement, the pressure generation unit is designed as a structural unit with a brake master cylinder. In one particular arrangement, a common housing is used for the pressure generation unit and the brake master cylinder. This arrangement leads to a further reduction in costs and a particularly compact structure.

In one exemplary arrangement, the planetary gear mechanism is interposed in the power flow between the electric drive motor and the rack-and-pinion gear mechanism. Starting from the electric drive motor, the planetary gear mechanism first converts an output power of the electric drive motor, which can be provided as a relatively small output torque with a relatively high speed, into an output power that is characterized by a significantly higher torque and a significantly lower speed. Due to the high gear ratios that can usually be achieved by planetary gear mechanisms, the use of a relatively low-torque and thus inexpensive drive motor is possible. Nevertheless, the hydraulic piston can be displaced with a sufficiently large force, which brings about a hydraulic pressure at a sufficient level,

In one exemplary arrangement, the electric drive motor can be a brushless DC motor. Such drive motors are relatively inexpensive and at the same time very reliable. Due to the lack of brushes, they also have a particularly long service life.

According to one exemplary arrangement, an effective axis of the hydraulic piston and a rotational axis of the electric drive motor are oriented perpendicularly to one another. In one exemplary arrangement, the effective axis of the hydraulic piston coincides with an effective axis of a rack of the rack-and-pinion gear mechanism. The rotational axis of the electric drive motor corresponds to a rotational axis of a pinion of the rack-and-pinion gear mechanism. The effective axis of the hydraulic piston and the rotational axis of the electric drive motor are thus a simple continuation of the effective and rotational axes of a conventional rack-and-pinion gear mechanism. Measures to shift or reorient these effective axes are not necessary. In this way, the pressure generation unit can be constructed in a compact manner, so that it can easily be arranged in confined spaces.

Furthermore, an output shaft of the electric drive motor can be coupled to a sun gear of the planetary gear mechanism in a rotationally fixed manner. This is structurally simple. In addition, a gear ratio suitable for driving the hydraulic piston can thus be provided with the planetary gear mechanism. In particular, a relatively large gear ratio of the planetary gear mechanism can be achieved such that, as already explained, a low-torque drive motor can be used.

According to a design alternative, in one exemplary arrangement, a planet carrier of the planetary gear mechanism or a ring clear of the planetary gear mechanism is coupled to a pinion of the rack-and-pinion gear mechanism in a rotationally fixed manner. Thus, the pinion of the rack-and-pinion gear mechanism can be operated at a suitable speed and torque in a simple and reliable manner,

The hydraulic piston can be rigidly connected to a rack of the rack-and-pinion gear mechanism. The hydraulic piston can thus be driven bidirectionally in a reliable manner. In particular, it has only a relatively small amount of play with respect to the rack. The hydraulic piston can therefore be moved with high precision.

In this context, the hydraulic piston can be designed as a single-acting hydraulic piston which, when displaced in a first direction, increases a pressure in the associated pressure fluid circuit and, when displaced in a second direction opposite to the first direction, relieves pressure from the pressure fluid circuit. Alternatively, the hydraulic piston can be designed as a so-called double-acting hydraulic piston. The pressure fluid circuit is then provided with a valve circuit known per se, which causes the piston to increase a pressure in the pressure fluid circuit regardless of its direction of displacement. Pressure can be built up particularly quickly with a double-acting hydraulic piston. In this case, the pressure is relieved in another way.

In an alternative arrangement, a motor control unit is arranged on a side of the electric drive motor facing away from the planetary gear mechanism. The motor control unit is thus positioned directly adjacent to the drive motor. The motor control unit and the drive motor can thus be easily connected in terms of signaling. The pressure generation unit also has a compact design.

Alternatively, a motor control unit is arranged on a side of the rack-and-pinion gear mechanism facing away from the planetary gear mechanism. This means that the pressure generation unit only takes up a relatively small installation space.

Advantageously, a rotational angle sensor element is positioned in or on an output shaft of the electric drive motor, the rotational angle sensor element being positioned at an end of the output shaft adjacent to the motor control unit. An associated rotational angle sensor unit is provided in the motor control unit. A rotational angle position of the electric drive motor can therefore be detected easily and reliably. This allows the pressure generation unit to be operated precisely.

### BRIEF DESCRIPTION OF DRAWINGS

The disclosure is explained below with reference to various exemplary arrangements which are shown in the accompanying drawings, in which:

FIG. 1 shows a pressure generation unit according to the disclosure in a first exemplary arrangement and

FIG. 2 shows a pressure generation unit according to the disclosure in a second exemplary arrangement.

### DETAILED DESCRIPTION

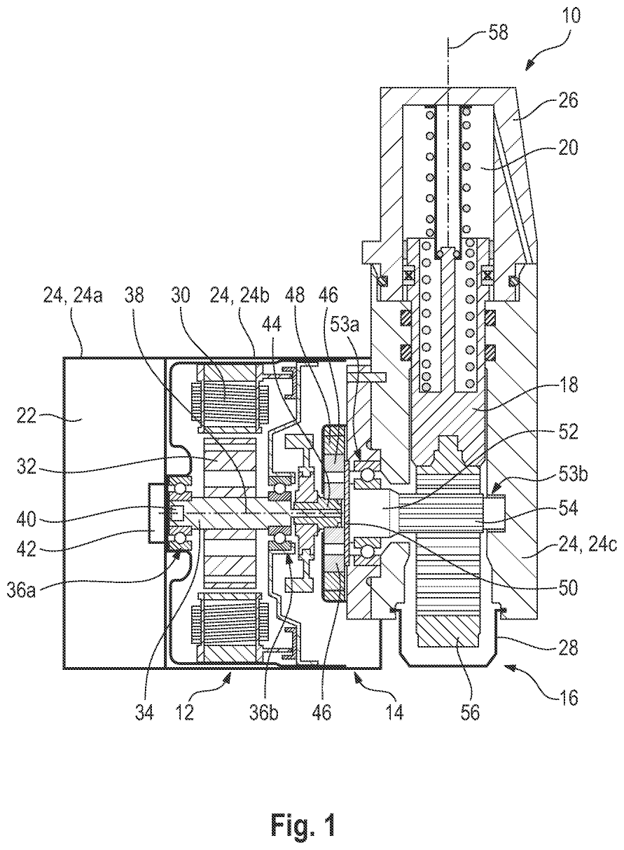

FIG. 1 shows a pressure generation unit 10 for a hydraulic braking system.

The pressure generation unit 10 comprises an electric drive motor 12 which is coupled to a hydraulic piston 18 via a planetary gear mechanism 14 and a rack-and-pinion gear mechanism 16.

The planetary gear mechanism 14 is located in a power flow between the electric drive motor 12 and the rack-and-pinion gear mechanism 16. The planetary gear mechanism 14 is also geometrically positioned between the electric drive motor 12 and the rack-and-pinion gear mechanism 16.

The hydraulic piston 18 delimits a pressure fluid circuit 20, which is represented in FIG. 1 by a pressure chamber.

A motor control unit 22 is also provided to control the drive motor 12. This is positioned on a side of the electric drive motor 12 facing away from the planetary gear mechanism 14.

In one exemplary arrangement, all components of the pressure generation unit 10 are arranged in a contiguous housing 24 which is composed of a control housing portion 24a, a drive housing portion 24b and a piston housing portion 24c. The piston housing portion 24c is also closed by a first end cap 26 and a second end cap 28.

Specifically, in the exemplary arrangement shown, the electric drive motor 12 is constructed as a brushless DC motor and comprises a stator 30 which is immovably mounted in the drive housing portion 24b.

The stator 30 interacts with a rotor 32 which is seated on an output shaft 34 of the electric drive motor 12.

The output shaft 34 is rotatably mounted on the drive housing portion 24b via two bearings 36a, 36b.

The output shaft 34 can thus be rotated together with the rotor 32 about a rotational axis 38.

A rotational angle sensor element 40 which interacts with a rotational angle sensor unit 42 of the motor control unit 22 is also arranged at an end of the output shaft 34 adjacent to the motor control unit 22.

A rotational angle position of the output shaft 34 of the drive motor 12 can be detected by the rotational angle sensor unit 42.

In addition, the output shaft 34 is coupled to a sun gear 44 of the planetary gear mechanism 14 in a rotationally fixed manner.

The sun gear 44 also interacts with planet gears 46 which mesh in a manner known per se with a ring gear 48 and are rotatably mounted on a planet carrier 50.

The planet carrier 50 is connected to a pinion shaft 52 of the rack-and-pinion gear mechanism 16 in a rotationally fixed manner.

The pinion shaft 52 is rotatably mounted in the drive housing portion 24b via a first bearing 53a and is rotatably mounted in the piston housing portion 24c via a second bearing 53b.

A rotational axis of the pinion shaft 52 coincides with the rotational axis 38 of the output shaft 34.

A pinion 54 is seated on the pinion shaft 52 or a pinion toothing is incorporated into the pinion shaft 52.

The pinion 54 meshes with a rack 56 which is rigidly connected to the hydraulic piston 18.

The hydraulic piston 18 can thus be displaced by operating the electric drive motor 12 and rotating the pinion 54 via the planetary gear mechanism 14.

The rotational drive movement is converted into a translational movement of the hydraulic piston 18 by the pinion 54 and the rack 56.

Depending on the direction of displacement of the hydraulic piston 18, the pressure fluid circuit 20 is supplied with pressure or relieved of pressure.

An effective axis 58 of the hydraulic piston 18 is oriented perpendicularly to the rotational axis 38 of the drive motor 12.

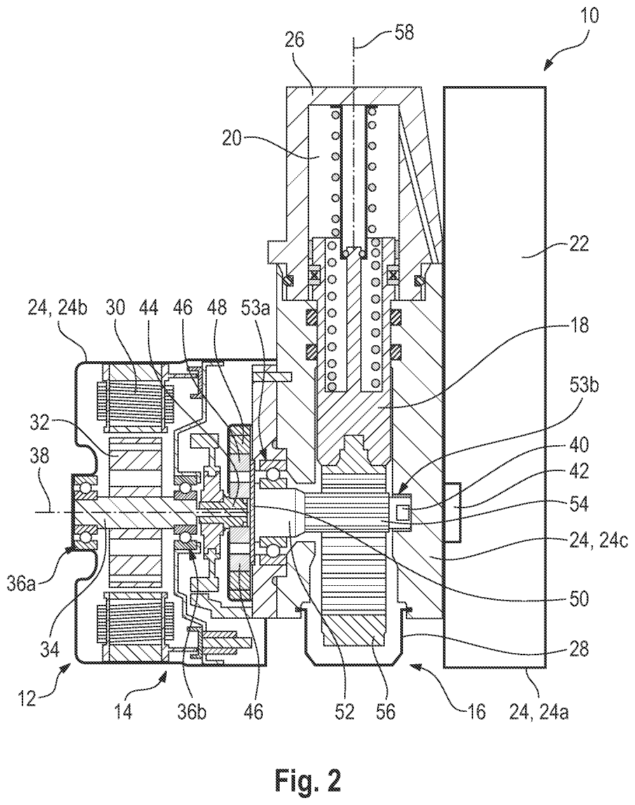

FIG. 2 shows a second exemplary arrangement of the pressure generation unit 10. Only the differences from the first exemplary arrangement of the pressure generation unit 10 are discussed here. The same reference signs are used for comparable or corresponding components.

The motor control unit 22 is now arranged on a side of the rack-and-pinion gear mechanism 16 facing away from the planetary gear mechanism 14.

In the second exemplary arrangement, the rotational angle sensor element 40 is positioned at an end of the pinion shaft 52 that is arranged adjacent to the motor control unit 22. A rotational angle position of the pinion shaft 52 can thus be detected by the rotational angle sensor unit 42.

Since a gear ratio of the planetary gear mechanism 14 is known, it can also be used to infer a rotational angle position of the output shaft 34 of the drive motor 12.

In both exemplary arrangements, the pressure generation unit 10 is designed to be mounted on an associated motor vehicle above a brake master cylinder.

It should be emphasized that the torque output via the planet carrier is not to be understood as limiting. The torque output can also take place via a movable ring gear when the planet carrier is stationary. There are also other options for the torque input, as is also known for planetary gear mechanisms.

1. A pressure generation unit for a braking system, comprising:
an electric drive motor and
a hydraulic piston which is displaceable by the electric drive motor in order to selectively apply pressure to or relieve pressure from a pressure fluid circuit delimited by the hydraulic piston,
wherein the electric drive motor is drivingly coupled to the hydraulic piston via a planetary gear mechanism and a rack-and-pinion gear mechanism.

2. The pressure generation unit according to claim 1, wherein the planetary gear mechanism is interposed in a power flow between the electric drive motor and the rack-and-pinion gear mechanism.

3. The pressure generation unit according to claim 1, wherein the electric drive motor is a brushless DC motor.

4. The pressure generation unit according to claim 1, wherein an effective axis of the hydraulic piston and a rotational axis of the electric drive motor are oriented perpendicularly to one another.

5. The pressure generation unit according to claim 1, wherein an output shaft of the electric drive motor is coupled to a sun gear of the planetary gear mechanism in a rotationally fixed manner.

6. The pressure generation unit according to claim 1, wherein, a planet carrier of the planetary gear mechanism or a ring gear of the planetary gear mechanism is coupled to a pinion of the rack-and-pinion gear mechanism in a rotationally fixed manner.

7. The pressure generation unit according to claim 1, wherein the hydraulic piston is rigidly connected to a rack of the rack-and-pinion gear mechanism.

8. The pressure generation unit according to claim 1, wherein a motor control unit is arranged on a side of the electric drive motor facing away from the planetary gear mechanism.

9. The pressure generation unit according to claim 1, wherein a motor control unit is arranged on a side of the rack-and-pinion gear mechanism facing away from the planetary gear mechanism.

10. The pressure generation unit according to claim 8, wherein a rotational angle sensor element is positioned in or on an output shaft of the electric drive motor, the rotational angle sensor element being positioned at an end of the output shaft adjacent to the motor control unit.

11. The pressure generation unit according to claim 2, wherein the electric drive motor is a brushless DC motor.

12. The pressure generation unit according to claim 2, wherein an effective axis of the hydraulic piston and a rotational axis of the electric drive motor are oriented perpendicularly to one another.

13. The pressure generation unit according to claim 12, wherein an output shaft of the electric drive motor is coupled to a sun gear of the planetary gear mechanism in a rotationally fixed manner.

14. The pressure generation unit according to claim 13, wherein an output shaft of the electric drive motor is coupled to a sun gear of the planetary gear mechanism in a rotationally fixed manner.

15. The pressure generation unit according to claim 14, wherein, a planet carrier of the planetary gear mechanism or a ring gear of the planetary gear mechanism is coupled to a pinion of the rack-and-pinion gear mechanism in a rotationally fixed manner.

16. The pressure generation unit according to claim 15, wherein the hydraulic piston is rigidly connected to a rack of the rack-and-pinion gear mechanism.

17. The pressure generation unit according to claim 16, wherein a motor control unit is arranged on a side of the electric drive motor facing away from the planetary gear mechanism.

18. The pressure generation unit according to claim 7, wherein a motor control unit is arranged on a side of the rack-and-pinion gear mechanism facing away from the planetary gear mechanism.

19. The pressure generation unit according to claim 18, wherein a rotational angle sensor element is positioned in or on an output shaft of the electric drive motor, the rotational angle sensor element being positioned at an end of the output shaft adjacent to the motor control unit.

20. The pressure generation unit according to claim 9, wherein a rotational angle sensor element is positioned in or on an output shaft of the electric drive motor, the rotational angle sensor element being positioned at an end of the output shaft adjacent to the motor control unit.
